(19) United States
(12) Patent Application Publication
(10) Pub. No.: US 2009/0237912 A1
(43) Pub. Date: Sep. 24, 2009

(54) Personal article with electron luminescent display

(76) Inventors: Yun-Yu TSAI, San Chung City (TW); Ping-Long WANG, Yuanli Township (TW)

Correspondence Address: BACON & THOMAS, PLLC, 625 SLATERS LANE, FOURTH FLOOR, ALEXANDRIA, VA, 22314-1176, US

(21) Appl. No.: 12/076,464

(22) Filed: Mar. 19, 2008

(51) Int. Cl. F21V 9/16

(52) U.S. Cl. 362/84

(57) ABSTRACT

A personal article includes an electron luminescent display (ELD), a circuit protection tube, a power supply circuit, a personal article body and a plurality of plastic membranes, wherein two electrodes of the ELD are connected to an electrode conducting wire, the circuit protection tube is made of a plastic material for covering and protecting the two electrode conducting wires, the power supply circuit is fixed into the personal article body and connected to the electrode conducting wire for supplying electric power to the ELD, an extended portion is formed around the plastic membrane for sealing the ELD, and the ELD is sewed or adhered onto the personal article body through the extended portion, and at least one connecting plate is extended axially from the circuit protection tube and is sewed or adhered onto the personal article. Therefore, the personal article can improve the nighttime visibility.

### FIELD OF THE INVENTION

The present invention relates to a personal article, and more particularly to a personal article with an electron luminescent display for effectively improving the nighttime visibility of the personal article and greatly improving the personal safety during nighttime activities.

### BACKGROUND OF THE INVENTION

In recent years, people pay more attentions on the concept of “Green” transportation due to the price of international petroleum, the shortage of energy sources and the greenhouse effect, and a bicycle boom occurs at all places over the world. People choose bicycles as the transportation means, not just for leisure, exercise and fitness only, but also for environmental protection and energy saving. The population of bicycle riders increases every year, and the time of riding a bicycle is extended, and more and more people ride their bicycles at dusk and nighttime.

At present, many people install a general light bulb or an LED flash light on the bike for the illumination at nighttime, but the light emitting devices regardless of their types are usually installed at the front of the bicycle. Such arrangement simply provides riders an illumination of the road conditions in the front, but gives no warning effect to drivers of the cars coming from behind. Although some people also install a warning lamp at the rear of the bicycle to improve the warning effect at nighttime, such arrangement allows drivers of fast coming cars from behind to estimate the position of a bicycle by a tiny light spot of the warning lamp, but the drivers cannot determine the exact position of the rider, and thus resulting in accidents frequently. When a rider pulls the bicycle to a curb for a rest, examines the bicycle, or pushes the bicycle uphill, the drivers of the cars from the back have no way of determining the actual distance between the rider and the bicycle and may hit the rider directly and result in a serious and fatal accident.

Therefore, it is an important object for designers and manufacturers of various bicycle accessories (including caps, helmets, backpacks, clothes and shoes) to improve the bicycle riders' visibility at night in addition to the visibility of the bicycle in order to actually protect the riders' personal safety.

In recent years, although many bicycle accessory manufacturers attempt to install light emitting devices such as LED or LCD on various different bicycle accessories or personal articles to improve the riders' visibility at nighttime, the LED or LCD devices are made by packaging a glass substrate which is a hard material and not suitable to be installed on a personal article in a comfortable and attachable manner. Furthermore, the light emitting devices cannot be sewed or installed to the bicycle accessories or personal articles easily, and thus the bicycle accessories or personal articles having the LED, LCD or other light emitting devices come with a high price, and an uncomfortable and poor attachment. Designs and manufactures of products of this kind have no commercial appeal to bicycle riders and thus cannot be used extensively in bicycles.

### SUMMARY OF THE INVENTION

In view of the foregoing shortcomings of the prior art, the inventor of the present invention based on years of experience in the related industry to conduct extensive researches and experiments, and finally developed a personal article with an electro luminescent display in accordance with the invention, in hope of using the light emitting capability and material characteristics of the electron luminescent display body to effectively overcome the shortcomings of the prior art and greatly improve the personal safety of wearing a personal article for nighttime activities.

An objective of the present invention is to provide a personal article with an electron luminescent display, and the personal article comprises an electron luminescent display (ELD), a circuit protection tube, a power supply circuit, a personal article body (such as a cap, a helmet, a backpack, clothes and shoes, etc) and a plurality of plastic membranes, wherein an end of the electron luminescent display has two electrodes connected to an end of an electrode conducting wire, and the circuit protection tube is made of a plastic material by extrusion molding or injection molding for covering and protecting the two electrode conducting wires, and the power supply circuit is water-tightly fixed into the personal article body and connected to another end of the electrode conducting wire for supplying electric energy required for the normal light emission of the electron luminescent display, and an extended portion is formed around the periphery of the plastic membrane for water-tightly sealing the electron luminescent display in the plastic membranes, and the electron luminescent display is sewed or adhered onto the personal article body through the extended portion, and at least one connecting plate is extended outward from a surface of the circuit protection tube, and each connecting plate is extended axially along the circuit protection tube, and the circuit protection tube is sewed or adhered onto the personal article body through the connecting plate. Therefore, the produced personal article with the electron luminescent display can effectively improve the nighttime visibility of the personal article to greatly improve the bicycle riders' personal safety for their nighttime activities.

Another objective of the present invention is to form an extended portion around the periphery of the plastic membrane, such that the electron luminescent display body can be easily sewed or thermally fused onto the personal article body through the extended portion to overcome the difficulty of sewing the LED, LCD or other light emitting devices onto the personal article in a traditional way, so as to effectively lower the production and manufacturing costs of the personal articles and greatly improve the comfort and attachment of the personal articles.

A further objective of the present invention is to install at least one connecting plate extended outward from the circuit protection tube, such that the circuit protection tube can be sewed or adhered easily onto the personal article through the connecting plate. Such arrangement not only effectively overcomes the difficulty of sewing the LED, LCD or other light emitting devices onto the personal article in a traditional way, but also greatly enhances the overall aesthetic appearance of the personal articles.

To make it easier for our examiner to understand the shape, structure, design principle and performance of the present invention, we use preferred embodiments together with the attached drawings for the detailed description of the invention as follows:

### BRIEF DESCRIPTION OF THE DRAWINGS

FIG. 1 is an exploded view of an electron luminescent display and other related components in accordance with the present invention;

FIG. 2 is a perspective view of an electron luminescent display and other related components in accordance with the present invention;

FIG. 3 is a schematic view of a first preferred embodiment of the present invention; and

FIG. 4 is a schematic view of a second preferred embodiment of the present invention.

### DETAILED DESCRIPTION OF THE PREFERRED EMBODIMENTS

As information technologies are developed rapidly, flat panel display (FPD) has become a mainstream of display devices, and is used extensively in various electronic products or electric appliances such as televisions, automobile meter panels, watches, and commercial billboards, etc to display textual or graphic information for our daily life. At present, flat panel display can be divided into three main types, respectively liquid crystal display (LCD), plasma display panel (PDP) and electron luminescent display (ELD). Since LCD has the features of long life and lower power consumption, the LCD has been used extensively in portable computers and various portable electronic products (such as mobile phones and personal digital assistant); PDP has the advantages of high brightness and large size, and thus PDP has been used extensively in digital televisions. However, LCD still has the drawbacks of poor viewing angle, slow response of animation, complicated structure, difficulty to be produced in large dimensions and high production cost, and PDP still has the drawbacks of short using life, high power consumption, complicated structure and high production cost. Obviously, both LCD and PDP are not suitable to be used in personal articles (including caps, helmets, backpacks, clothes and shoes). ELD has the features of good viewing angle, emitting light without generating heat and flexible screen and comes with a light, thin, short and small design, and thus ELD has the potential to be used in various personal articles.

Electron luminescence (EL) was first discovered by a German scientist, Dr. Destria in 1936, and EL is a technology with a history of 60 years. Till recent years, solid-state chemistry and thin film semiconductor technologies are developed before electron luminescent display (ELD) gradually attracts our attention. ELD can be divided into organic ELD (OELD) and inorganic ELD according to the light emitting material. In the past, most researches are conducted primarily for inorganic ELDs, and OELD has breakthroughs on its operation, life expectancy and commercial applications, and thus OELD has been used extensively in various different electronic products. In 1974, a Japanese company, Inoguchi announced a thin film ELD structure having two insulating layers to effectively overcome the issues of light emitting intensity and life expectancy. In 1983, another Japanese company Sharp first introduced a monochrome 320×240 (dots) ELD. In 1988, an American company, Planar Systems launched a true color ACTFEL (Alternating Current Thin Film Electroluminescent) 320×240 (dots) ELD. Later, Planar Systems Company also commercialized the color ELD products by introducing a full color ELD prototype sample in 1993.

The basic structure of ELD includes an electrode material, an insulating material and a luminescent material. Similar to the semiconductor material, the luminescent material is a luminescence center mainly composed of a host material and an appropriate dopant (or activator). At present, most developed host materials are Group (II-VI) ionic compounds substantially including Ca, Sr and Ba (Group IIA) or Zn, Cd and Hg (Group IIB) to go with S and Se (Group VI), and the dopant determines the color of the emitted light, and most dopants are transitional metals such as Mn, Cu, Ag and lanthanide elements (Eu, Sm and Tb). Since the light emitting mechanism involves a filling of cations in holes and crevices, it is necessary to add a monovalent or trivalent matter such as halogens (F, Br and Cl) for balancing the electrically charged matter if the dopant is not a bivalent metal. The electrically charged matter is a co-activator, and its light emission relates to the principle of impacting electrons at an outer layer of the activator of the luminescence center to shift the electrons and increase the energy level of electrons at the outer layer to the energy level of the host crystal conduction band and produce free electrons, so that the luminescence center is ionized. Finally, the free electrons are combined with the ionized luminescence center, and the energy gap is released in form of light to release a color light with stable intensity and efficiency. The “Electron luminescent display” described in this specification refers to any soft flexible electron luminescent display (ELD).

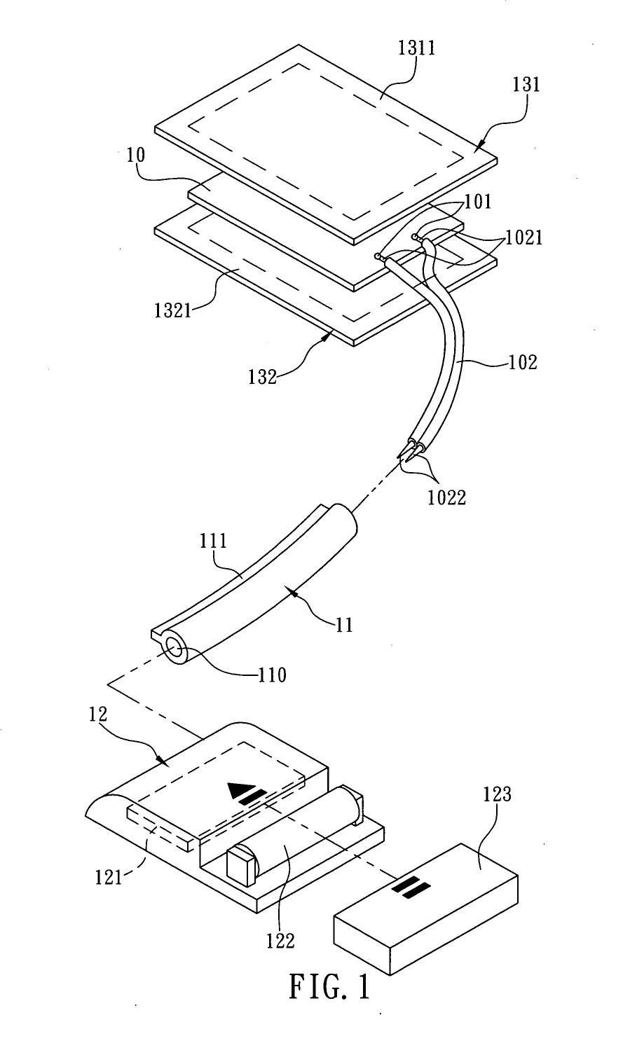

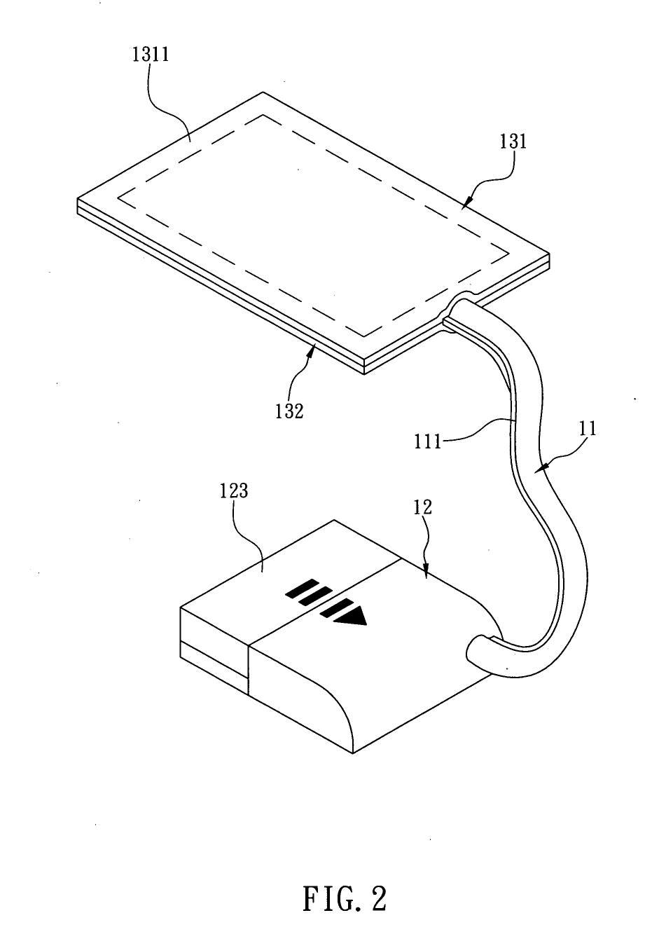

The present invention applies an electron luminescent display having the feature of power saving, stable color light, generating no heat, soft, flexible, light, thin, short and compact to the design and manufacture of personal article (including caps, helmets, backpacks, clothes and shoes) and develop a personal article with an electron luminescent display in accordance with the present invention as shown in FIG. 1. The invention comprises an electron luminescent display (ELD) 10, a circuit protection tube 11, a power supply circuit 121 and a plurality of plastic membranes 131, 132, wherein two electrode terminals 101 of the electron luminescent display 10 are separately connected to an end 1021 of an electrode conducting wire 102, and the circuit protection tube 11 is produced by performing an extrusion molding or injection molding to a plastic material, and the circuit protection tube 11 has a penetrating hole 110 for passing the electrode conducting wire 102 and covering the electrode conducting wire 102 in the circuit protection tube 11, and the power supply circuit 121 is water-tightly packaged into a casing 12 to prevent the power supply circuit 121 from being moistened or short circuited, and a containing space is disposed at an end of the casing 12 for installing a battery 122 to supply electric power for the normal operation of the power supply circuit 121, and a cover 123 is installed at a position corresponding to the containing space of the casing 12 and integrally embedded with the casing 12, such that the battery 122 is fixed into the containing space without the risk of falling out. The casing 12 is fixed to a personal article body (such as a cap, a helmet, a backpack, a piece of clothes and a shoe) and coupled to another end 1022 of the electrode conducting wire 102 to provide electric power required for the normal light emission of the electron luminescent display 10. In FIG. 2, extended portions 1311, 1321 are formed around the periphery of the plastic membranes 131, 132, and the extended portions 1311, 1321 can be coupled with each other by thermal bonding, such that the electron luminescent display 10, the two electrode terminals 101 and the end 1021 of the electrode conducting wire 102 are water-tightly packaged in the plastic membranes 131, 132 to protect the electrode terminal 101 and the end 1021 of the electrode conducting wire 102 from moisture and short circuit. The electron luminescent display 10 is sewed or adhered onto the personal article body through the extended portions 1311, 1321, and at least one connecting plate 111 is extended outward from a surface of the circuit protection tube 11, and each connecting plate 111 is extended axially along the circuit protection tube 11, and the circuit protection tube 11 is sewed or adhered onto the personal article body through the connecting plate 111, and thus the produced personal article can emit lights by means of the electron luminescent display 10 to effectively improve the nighttime visibility of the personal article, so as to greatly enhance the personal safety of the wearers for their activities at nights.

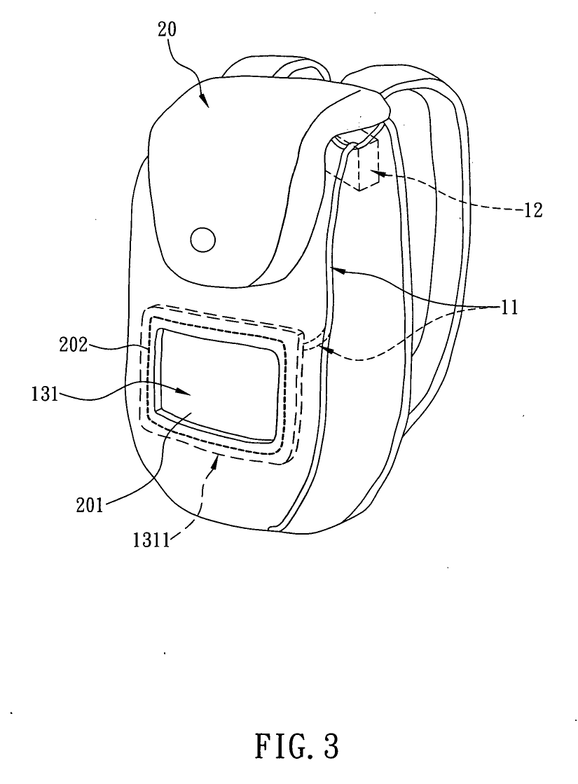

In a first preferred embodiment of the present invention, a backpack 20 is used as an example of the personal article body to illustrate the invention. In FIG. 3, an opening 201 is disposed on an external surface of the backpack 20 and the size of the opening 201 is equal to the size of the electron luminescent display 10 and smaller than the size of the plastic membranes 131, 132. In the manufacture of the backpack 20, operators can place the electron luminescent display 10 packaged with the plastic membranes 131, 132 into the backpack 20 and at a position corresponding to the opening 201, so that the extended portions 1311, 1321 at the periphery of the plastic membranes 131, 132 are superimposed with the positions of the backpack 20 and proximate to the periphery of the opening 201, and operators can use a sewing machine (or a hot press sealer) to fix the extended portions 1311, 1321 at the periphery of the plastic membranes 131, 132 onto the backpack 20 and at positions proximate to the periphery of the opening 201 by sewing or thermal bonding. Further, a stitch 202 is formed around the periphery of the backpack 20 and proximate to the opening 201, such that the electron luminescent display 10 is exposed from the opening 201 of the backpack 20, and then operators can align a connecting plate 111 on the surface of the circuit protection tube 11 with the stitching on the external surface of the backpack 20, and use the sewing machine or hot press sealer to fix the connecting plate 111 of the circuit protection tube 11 to the stitching on the external surface of the backpack 20 by sewing or thermal bonding. Further, the casing 12 of the power supply circuit 121 disposed on another end of the circuit protection tube 11 is fixed into the backpack 20, so that a light emitting backpack having both aesthetic appearance and safety can be produced successfully without affecting the normal manufacturing procedure of the backpack 20 at all, so as to effectively improve the nighttime visibility of the backpack and the personal safety of the wearers for their nighttime activities.

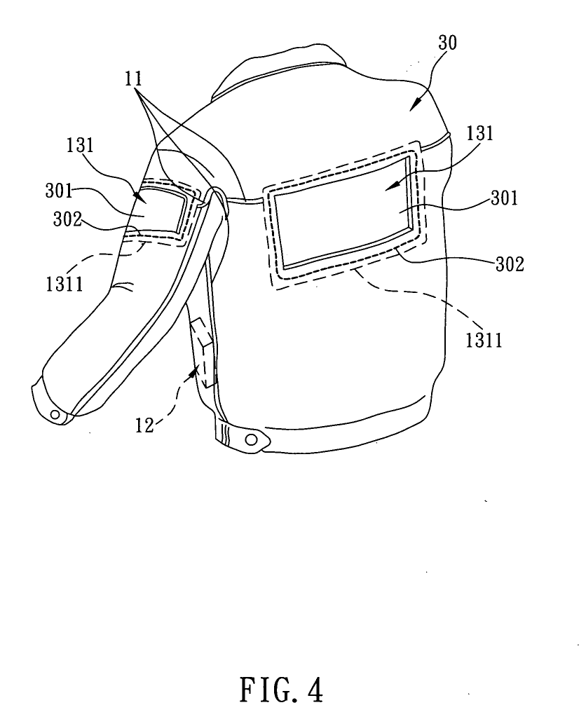

In a second preferred embodiment of the present invention, a jacket 30 is used as an example of the personal article body for illustrating the invention, In FIG. 4, an opening 301 is designed separately on corresponding back and arm positions of the jacket 30, and the size of the openings 301 is equal to the size of the corresponding electron luminescent display 10 and smaller than the size of the plastic membranes 131, 132, such that when the jacket 30 is manufactured, operators can place the two electron luminescent displays 10 with packaged plastic membranes 131, 132 into the jacket 30 and at positions corresponding to the two openings 301 first, and the extended portions 1311, 1321 at the periphery of the plastic membranes 131, 132 are superimposed on the jacket 30 and proximate to the periphery of the two openings 301, and operators can use a sewing machine (or a hot press sealer) to fix the extended portions 1311, 1321 at the periphery of the plastic membranes 131, 132 onto the jacket 30 and at positions proximate to the periphery of the opening 301 by sewing or thermal bonding, and a stitch 302 is formed on an external surface of the jacket 30 and around the periphery of the opening 301, such that the two electron luminescent displays 10 are exposed from the two openings 301 of the jacket 30, and operators can align a connecting plate 111 on a surface of the circuit protection tube 11 with the stitching on the external surface of the jacket 30, and use a sewing machine (or hot press sealer) to fix the connecting plate 111 of the circuit protection tube 11 to the stitching on the external surface of the jacket 30 by sewing or thermal bonding. The casing 12 of the power supply circuit 121 connected to another end of the circuit protection tube 11 is fixed into a pocket of the jacket 30, so that a light emitting backpack having both aesthetic appearance and safety can be produced successfully without affecting the normal manufacturing procedure of the jacket 30 at all, so as to effectively improve the nighttime visibility of the jacket and the personal safety of the wearers for their nighttime activities.

In the foregoing preferred embodiment, the plastic membrane 131 corresponding to the opening on an external side of the personal article body is made of a transparent plastic material, and thus the light produced by the electron luminescent display 10 can pass through the plastic membrane 131 and disperse from the opening on the external side of the personal article body. In other embodiments of the present invention, a pattern such as a word, a line or a color is printed directly on an external surface of the transparent plastic membrane 131 depending on the actual needs, or a plastic film printed with a pattern such as a word, a line or a color is coated, so that when the electron luminescent display 10 generates light, the light with the pattern including a word, a line or a color can be displayed on the external surface of the transparent plastic membrane 131 to effectively enhance the nighttime visual effect of the personal article and greatly improve the personal safety of the wearers for their nighttime activities. Further, two or more connecting plates can be installed on the surface of the circuit protection tube as needed to cope with two or more stitching positions on the external side of the personal article body, and a sewing machine (or a hot press sealer) is used for fixing the connecting plates of the circuit protection tube onto the stitching positions corresponding to the external surface of the personal article body.

In summation of the description above, the invention is illustrated by several preferred embodiment, but not limited to the applications of a backpack or a jacket. The invention can be applied to many other personal articles such as caps, helmets and shoes, etc to improve the safety of using these personal articles at nights. In addition, any ordinary person skilled in the art can place the electron luminescent display 10 packaged with the plastic membranes 131 on an external side of the personal article body, and use a sewing machine (or a hot press sealer) to fix the extended portions 1311, 1321 at the periphery of the plastic membranes 131, 132 directly onto the external side of the personal article body to simplify the manufacturing procedure. It is noteworthy to point out that many other modifications are conceivable within the scope of the following claims.

What is claimed is:

1. A personal article with an electron luminescent display, comprising:
a personal article body;
a circuit protection tube, made of a plastic material by extrusion molding or injection molding, and having a penetrating hole disposed therein, and at least one connecting plate extended outward from a surface of the circuit protection tube, and each connecting plate being extended axially along the circuit protection tube, and the circuit protection tube being fixed onto the personal article body through the connecting plate by sewing or thermal bonding;
an electron luminescent display, having two electrode terminals disposed thereon, and respectively coupled to an end of an electrode conducting wire, and the electrode conducting wire being passed through the penetrating hole and wrapped into the circuit protection tube;
a power supply circuit, water-tightly fixed into the personal article body, and coupled to another end of the electrode conducting wire, for supplying electric energy required for the normal operation of the electron luminescent display; and
a plurality of plastic membranes, forming an extended portion around the periphery of each plastic membrane, and the extended portions are bonded together by thermal bonding to water-tightly seal the electron luminescent display, the two electrode terminals and an end of the electrode conducting wire into the plastic membranes, and the electron luminescent display is fixed onto the personal article body through the extended portion by sewing or thermal bonding.

2. The personal article with an electron luminescent display of claim 1, further comprising a casing fixed into the personal article body, and the power supply circuit is packaged water-tightly in the casing, and an end of the casing has a containing space for installing a battery to supply electric energy required by the normal operation of the power supply circuit, and a corresponding position of the containing space of the casing further includes a cover integrally engaged with the casing to position the battery in the containing space.

3. The personal article with an electron luminescent display of claim 2, wherein the personal article body has an opening disposed on an external surface of the opening, and the size of the opening is equal to the size of the electron luminescent display and smaller than the size of the plastic membrane, and the electron luminescent display sealed with the plastic membrane is installed at a position in the opening corresponding to the personal article body, such that the extended portion at the periphery of plastic membrane is overlapped with a position on the personal article body and proximate to the periphery of the opening, and fixed to a position on the personal article body and proximate to the opening by sewing or thermal bonding.

4. The personal article with an electron luminescent display of claim 3, wherein the connecting plate on a surface of the circuit protection tube is aligned with a stitching position on an external surface of the personal article body, and fixed onto a stitching position on the external surface of the personal article body by sewing or thermal bonding.

5. The personal article with an electron luminescent display of claim 4, wherein the plastic membrane corresponding to the opening on an external side of the personal article body is made of a transparent plastic material.

6. The personal article with an electron luminescent display of claim 5, wherein the transparent plastic membrane has a pattern, a word, a line or a color printed directly on an external surface of the transparent plastic membrane.

7. The personal article with an electron luminescent display of claim 5, wherein the transparent plastic membrane is coated with another plastic membrane having a pattern, a word, a line or a color printed on an external surface of the plastic membrane.
